(19) United States
(12) Patent Application Publication
(10) Pub. No.: US 2008/0064015 A1
(43) Pub. Date: Mar. 13, 2008

(54) Devices for teaching elementary fractional concepts

(76) Inventor: Barbara E. Garmirian, Reading, PA (US)

Correspondence Address: LITMAN LAW OFFICES, LTD., P.O. BOX 15035, CRYSTAL CITY STATION, ARLINGTON, VA, 22215, US

(21) Appl. No.: 11/898,511

(22) Filed: Sep. 12, 2007

Related U.S. Application Data
(60) Provisional application No. 60/844,091, filed on Sep. 13, 2006.

(51) Int. Cl. G09B 23/02

(52) U.S. Cl. 434/211

(57) ABSTRACT

The devices for teaching elementary fractional concepts each include a board having a raised periphery and central depression representing unity. Each embodiment includes a series of fractional pieces of different sizes for removable installation therein, with the number of pieces of each size having a total span equal to the span of the central depression. Thus, each piece represents the denominator of a fractional portion of the central recess. The pieces may be stacked in several layers, thus demonstrating the equivalency of different sizes of fractional pieces subtending the same area of the recess. The devices may be formed in rectangular or circular configurations, and may represent the basic abstract concept of fractions, monetary values in different systems, time and divisions thereof, etc. Separate boards may be provided for each embodiment, or inserts may be provided for placement within recesses of correspondingly configured boards.

### CROSS-REFERENCE TO RELATED APPLICATION

This application claims the benefit of U.S. Provisional Patent Application Ser. No. 60/844,091, filed Sep. 13, 2006.

### BACKGROUND OF THE INVENTION

1. Field of the Invention

The present invention relates generally to educational tools and devices used for teaching various concepts and skills. More specifically, the present invention relates to devices for teaching elementary fractional concepts encompassing boards or trays, each board or tray having a central recess therein. A series of fractional pieces having sizes proportional to the fractional values represented may be installed in and removed from the central recess, and different sizes of pieces representing different fractional denominators may be placed in a series of layers within the recess.

2. Description of the Related Art

The teaching of most mathematical concepts, including the concept of fractions, is traditionally accomplished by means of blackboard and chalk, pencil and paper, and/or textbooks and workbooks. None of these means provide a solid, three-dimensional, hands-on experience for the student. The result is that many, if not most, students have at least some degree of difficulty in grasping the subject, particularly younger children first learning about fractions. Somewhat the same points apply to teaching younger children about basic money and coin values, in that the basic unit of currency is subdivided into smaller units (e.g., dollars and cents) for just about every currency in the world. At least when learning about the monetary system, the student may actually handle the units (coins, etc.) while gaining some familiarity with their relative values. However, most monetary systems use coins that are often not proportional in size and weight to the values represented. This results in further difficulties for the student learning about basic monetary values, whether in one's native currency or when learning about a foreign currency for a trip abroad.

As a result, a few devices and systems for teaching fractions and monetary values have been developed in the past. Simulated currency (“play money”) has often been used in the past for teaching the value of currency and more particularly paper or folding money, with some development of simulated coins being done in the past as well. A major problem with simulated coins is that they represent the actual sizes of the coins represented, rather than providing any components having proportional sizes to the values of the coins represented. This can make it difficult for the student to grasp the relative values of the coins represented. Others have developed boards with various removable overlays representing different monetary or fractional values. The plethora of such devices attests to the continuing need for tools for teaching fractional concepts.

Thus, devices for teaching elementary fractional concepts solving the aforementioned problems are desired.

### SUMMARY OF THE INVENTION

The devices for teaching elementary fractional concepts comprise a series of embodiments, each embodiment including a board having a relatively large central recess defined by a raised periphery. The central recess represents unity, or a value of one unit. Each embodiment further includes a series of fractional pieces of different sizes proportional to their fractional values and representing the denominator of a fraction. For example, each piece of a series of four fractional pieces subtends one fourth of the area of the central recess, with each of a series of ten pieces subtending one tenth of the area, etc. Multiple layers of the fractional pieces may be installed atop one another in order to clearly show the equivalent values of different fractions, e.g., five 1/10 pieces may be placed atop two ¼ pieces, subtending exactly the same half board area for both and clearly showing their equivalence. Thus, the student can readily see the sizes of the pieces relative to one another and to the size of the central recess of the board to grasp the concept of the fractional quantity represented.

The devices for teaching elementary fractional concepts may be applied to abstract fractional numerical values, and may also be applied to a special case for teaching basic monetary values as well. In the case of the monetary teaching device, the central depression may include a representation of a basic unit of currency, e.g., one dollar, with fractional pieces representing various coin values and subtending areas of the central depression proportional to their values. The same principle may be applied to various currencies of different nations as well. The currency teaching device may be constructed as a stand-alone device, or may be formed as an insert for removable installation within the central depression of the basic fractional teaching device.

The devices may be formed in rectangular configurations with the fractional pieces extending from one edge to the other and having a lateral span or width proportional to their fractional values, or may be formed in circular configurations with each of the fractional pieces subtending a circular sector. In the case of the circular configurations, one embodiment may include a set of selectively positionable clock hands, with the periphery of the board marked in hours and minutes. The fractional pieces may be marked to represent the minutes corresponding to the fractional value of the piece, e.g., a piece covering ⅙ of the circular area could be marked to indicate ten minutes, etc. In any event, all embodiments utilize the common theme of the central depression and multiple values of fractional pieces removably installable therein in multiple layers to show the equivalence of various fractional values.

These and other features of the present invention will become readily apparent upon further review of the following specification and drawings.

### BRIEF DESCRIPTION OF THE DRAWINGS

FIG. 1 is an exploded perspective view of a first embodiment comprising a rectangular board and fractional pieces for teaching fractions according to the present invention.

FIG. 2 is an exploded perspective view of a removably installable insert for the board of FIG. 1 and fractional pieces for use therewith, with the insert and pieces representing various U.S. monetary values.

FIG. 3 is a perspective view of a group of fractional pieces representing different values of smaller denomination coins for use with the monetary teaching insert of FIG. 2.

FIG. 4 is an exploded perspective view of a removably installable insert for the board of FIG. 1, with the insert and fractional pieces representing various Euro coin monetary values.

FIG. 5 is an exploded perspective view of another alternative embodiment, comprising a circular board and recess with fractional pieces in the form of arcuate circular segments.

FIG. 6 is an exploded perspective view of a removably installable insert for the board of FIG. 5 and fractional pieces for use with the insert, with the insert and fractional pieces representing various U.S. coin values.

FIG. 7 is an exploded perspective view of another alternative embodiment, comprising a circular board and recess with selectively positionable clock hands therein and a series of fractional pieces representing periods of time.

Similar reference characters denote corresponding features consistently throughout the attached drawings.

### DETAILED DESCRIPTION OF THE PREFERRED EMBODIMENTS

The present invention comprises a series of embodiments of a device for teaching elementary fractional concepts, e.g., abstract arithmetical fractions, money and small change, time and fractions of an hour, etc. Each of the embodiments includes a board, or insert for a basic board, and a series of groups of fractional pieces, with each group having pieces of like size representing fractional pieces having the same denominator. The various pieces of each group are used to form various strata within the central recess of the board, with the student readily able to see the correspondence in value between different pieces when so overlaid within the board recess.

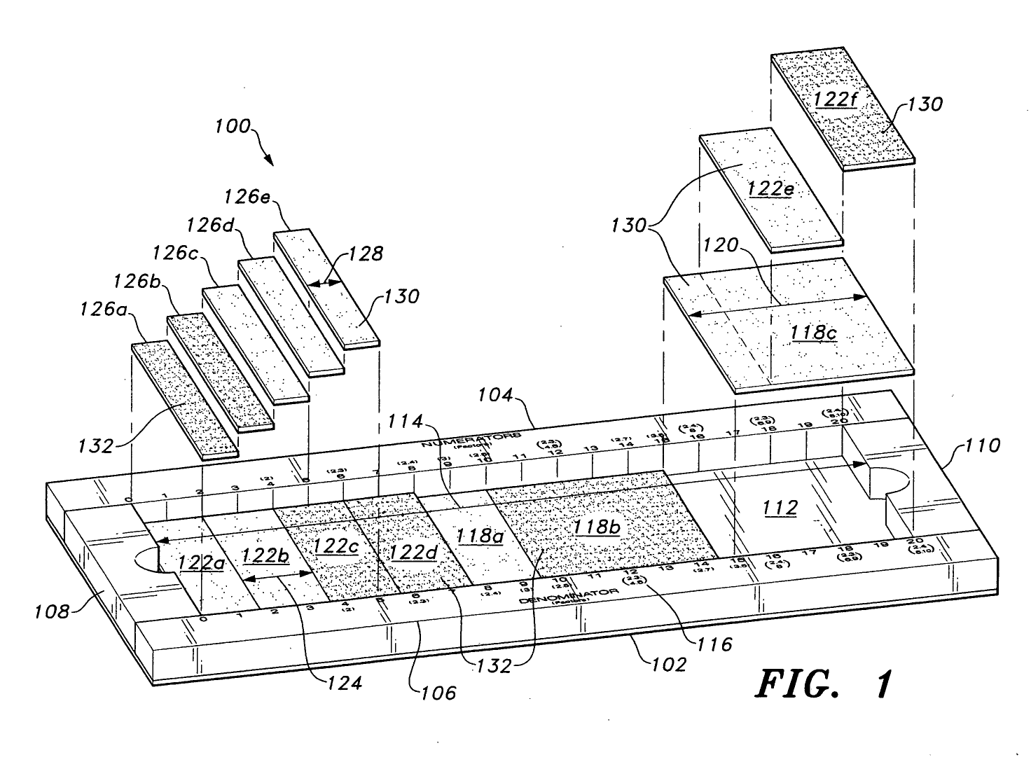

FIG. 1 provides an exploded perspective view of a first embodiment 100, comprising a rectangular board 102 having raised opposite first and second or major peripheral edges 1 04 and 106, and raised opposite third and fourth, minor or end peripheral edges 108 and 110. The raised peripheral edge components 104 through 110 form a continuous periphery defining a central recess 112 therein, with the recess 112 subtending a lateral span or major width 114 representing unity and extending between the inner edges of the two end peripheral edges 108 and 110. The first and second major peripheral edges 104 and 106 preferably include a series of numerical designators 116 thereon, representing arithmetical, monetary, or other values or quantities, as desired.

In the example of FIG. 1, the numerical designators 116 comprise a series of evenly spaced numbers representing fractional divisions of the major width or span 114 of the central recess 112, with other numbers indicating the factors of non-prime numbers as applicable, e.g., the fractional division 12 has its factors 2, 3, 4, and 6 in adjacent brackets. The numbers along the first or upper periphery 104 are used to represent the numerator of any fractional quantity being represented, and the numbers along the second or lower periphery 106 are used to represent the denominator. While a total of twenty divisions are shown along each of the peripheries 104 and 106, with each division being equal to 1/20 of the total span 114 of the central recess 112, it will be understood that any practicable number of divisions may be provided as desired.

A series of relatively thin, flat, planar fractional pieces is provided for removable placement within the central recess 112 of the board 102. Each series comprises a group of identically sized pieces each having a width less than the span 114 of the board recess 112, with all of the pieces in any one group having a total width equal to the board recess span 114.

In the example of FIG. 1, three different series of fractional pieces are shown. The first set or group comprising the largest pieces, e.g., pieces 118a, 118b, and 118c, comprises a total of four pieces (three of which are shown at least partially in FIG. 1), with each piece having a width 120 subtending one quarter of the span 114 of the central recess 112. The next group or set of pieces comprises a series of ten intermediate pieces, e.g., 122a, 122b, 122c, etc., each having a width 124 subtending one tenth of the central recess span 114. A third set of pieces comprises a series of twenty smaller pieces of which five are shown in FIG. 1, i.e., 126a through 126e. Each of these smaller pieces has a width 128 subtending one twentieth of the span 114 of the central recess 112.

Thus, each piece represents the denominator of a fraction, with the denominator being equal to the number of pieces within each group or set. One or more of the smaller pieces 126a, etc. could be subdivided to form even smaller pieces, if so desired, but this may not be practicable. Alternatively, one or more of the smaller fractional pieces 126a, etc. could be marked with lines indicating the division of the pieces into still smaller components, while still maintaining a practicable size for handling the pieces. It will be seen that the groups of pieces representing quarter, tenth, and twentieth fractions of the unit represented by the length of the board recess 112 may be adjusted as desired, with the number of pieces and corresponding fractional denominator for each group or set being any practicable integer as desired.

A single group of identical fractional pieces may be used to form a single complete stratum or layer of pieces within the central recess 112, completely filling the central recess, if so desired, with other groups of identical pieces being placed thereon to form multiple layers or strata of fractional pieces. Alternatively, fractional pieces of different groups may be placed within the same stratum to indicate the equivalency or relative value of a series of smaller pieces compared to a single one or smaller number of larger pieces. In the example of FIG. 1, it will be seen that the width 120 of a single larger fractional piece 118c subtends ¼, or 25%, of the total span 114 of the board recess 112, thus requiring a series of four such pieces to fill the recess 112 completely. In turn, two intermediate width pieces 122e and 122f are shown disposed above the larger fractional piece 118c. As each of the pieces 122e and 122f has a width 124 equal to one tenth of the total span 114 of the board recess 112, two such pieces 122e and 122f subtend only ⅘ of the width 120 of the larger ¼ piece 118c. The series of five 1/20 width pieces 126a through 126e will be seen to have a total width equal to 5/20, or ¼, of the total span 114 of the board recess, or in other words equal to the span or width 120 of a single ¼ piece. The various fractional pieces may be mixed and matched in various layers or strata to show the equivalencies of various fractions, generally as described above.

It will be noted that the various fractional pieces 118a through 126e, etc., are provided in two different colors or shades. For example, a first surface 130 of each of the pieces could be shaded in red, with the opposite second surface 132 colored black. The use of red and black are particularly suitable for embodiments of the present invention representing monetary fractions, i.e., subtraction and addition of monetary values or profit and loss. However, other colors may be used as desired.

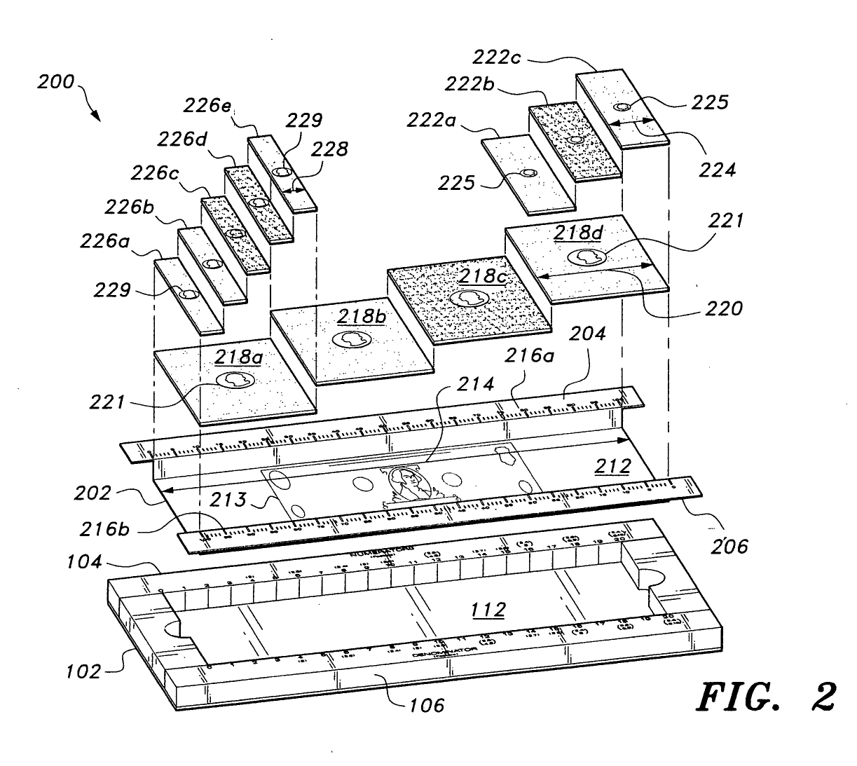

FIG. 2 of the drawings illustrates a second embodiment 200 of the present fractional teaching devices, comprising an insert 202 which may be used with the board 102 of FIG. 1 and a series of fractional pieces for teaching monetary values. The insert 202 essentially serves the same function as the board 102, i.e., the insert includes a pair of raised, opposed major peripheral edges 204 and 206 that define a central recess 212 therebetween. The recess 212 has a major width or span 214 equal to the width or span 114 of the board 102, with the recess 212 of the insert 202 fitting into the recess 112 of the board 102 and the two opposed major peripheries 204 and 206 being positioned over the respective peripheries 104, 106 of the board 102 when the insert 202 is placed thereover.

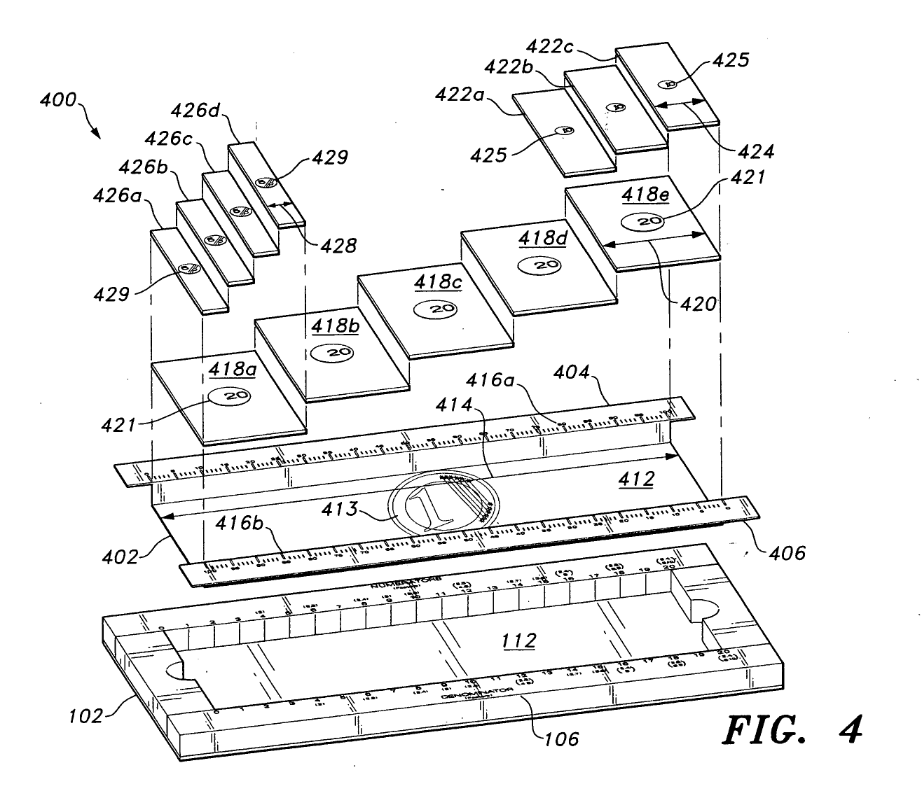

The purpose of the insert 202 is to provide different numerical designators along the two upper edges or peripheries 204, 206 of the device, which may be used to indicate different fractions or functions for the use of the device. In the example of the insert 202 of FIG. 2, the numerical designators 216a and 216b are graduated in hundredths, to represent percentile values or increments. This permits the insert 202 to be used for the teaching of relative monetary values found in coin or other divisions of a basic monetary unit, e.g., nickels, dimes, quarters, etc., with a dollar being the basic monetary unit. Accordingly, the recess 212 of the insert 202 may include a representation 213 of the basic monetary unit, e.g., a dollar bill, thereon. Two different numerical designators 116a and 116b are shown in FIG. 2, with their values increasing in opposite directions. This facilitates the concept of making change, i.e., subtracting the remainder of the change from a dollar from the amount due in a transaction. The inventive concept of FIG. 2 may be expanded to cover other than U.S. monetary systems as well, as exemplified in FIG. 4 and discussed further below. It will also be noted that the information provided on the insert 202 could be applied to a board similar to the board 102 of FIGS. 1 and 2, if so desired.

A series of relatively thin, flat, planar fractional monetary pieces is provided for removable placement within the central recess 212 of the insert 202. These monetary pieces are quite similar to the pieces 118a through 126e shown in FIG. 1 of the drawings and discussed further above, differing only in that each of the fractional monetary pieces of FIG. 2 includes a representation of a coin thereon corresponding to the fractional value of the piece. In the example of FIG. 2, three different series of fractional pieces are shown. The first set or group comprising the largest pieces, e.g., pieces 218a through 218d, comprises a total of four pieces, with each piece having a width 220 subtending one quarter of the span 214 of the central recess 212 of the insert 202 and representing the value of a quarter coin, or 25 cents. A 25-cent coin symbol or representation 221 may be provided upon each of the ¼ width monetary fractional pieces.

The next group or set of pieces comprises a series of ten intermediate pieces, e.g., 222a, 222b, 222c, etc., each having a width 224 subtending one tenth of the central recess span 214 of the insert 202. As there are ten such pieces, a dime representation 225 or coin having a value of one tenth of the monetary unit represented by the span 214 of the insert 202 may be provided on each piece. A third set of pieces comprises a series of twenty smaller pieces of which five are shown in FIG. 2, i.e., 226a through 226e. Each of these smaller pieces has a width 228 subtending one twentieth of the span 214 of the central recess 212 of the insert 202. A nickel representation 229, or other coin having a value of one twentieth of the base currency represented, may be provided on the surface of each of the smaller monetary fractional pieces 226a, etc.

One or more of the smaller pieces 226a, etc. could be subdivided to form even smaller penny or one cent pieces, if so desired, but this may not be practicable. Alternatively, one or more of the smaller fractional pieces could be marked with a plurality of smaller coins having a total value equivalent to that represented by the width of the fractional monetary piece.

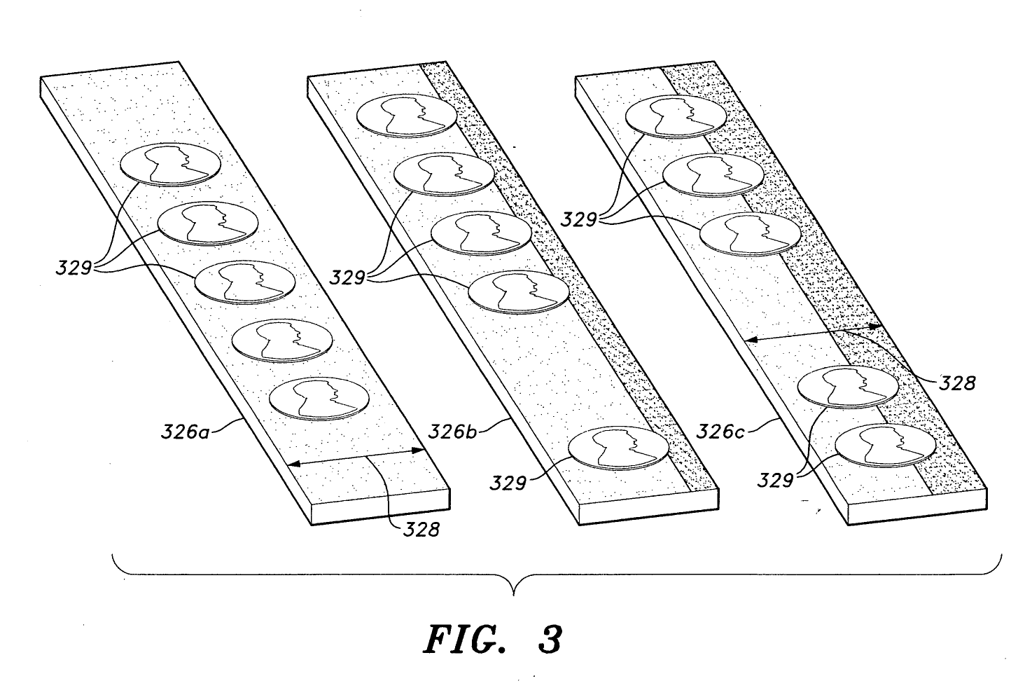

An example of the above is illustrated in FIG. 3 of the drawings, with a series of three fractional monetary pieces 326a, 326b, and 326c being shown. Each of the pieces 326a through 326c has a width 328 equal to the widths 228 of the pieces 226a through 226e of FIG. 2, i.e., 1/20, or 5/100, of the total span or width 214 of the insert recess 212. However, rather than displaying a single coin thereon, the pieces 326a through 326c of FIG. 3 have representations of a series of smaller coins having a total value equal to that of one of the equivalent pieces 226 of FIG. 2. The coin representations 329 on the pieces 326a through 326c are grouped to indicate different values and remainders, with the first piece 326a having all five of the one-cent coin representations 329 grouped together.

The next piece 326b shows only four such coins grouped together, with the fifth coin separated. This piece 326b also has one fifth of its width shown in a different color, e.g., black, to indicate the relative lessening of value of the piece. Finally, the piece 326c has two coins grouped separated, with a black pattern subtending two fifths of its surface. In this manner, the values of the smallest coins may be represented, without the need to subdivide the 1/20 width pieces into narrower pieces that are impracticable to handle. The relative percentages of the areas covered by each color, and the groupings of coins, may be reversed on the opposite sides of the pieces 326a, 326b, etc., in order to obviate need for a duplicate set of such multiple coin fractional monetary pieces.

FIG. 4 of the drawings illustrates an alternative insert and fractional piece configuration 400 for teaching the relative coin values of a monetary system other than the U.S. monetary system. The Euro monetary system is shown in the example of FIG. 4, but it should be noted that the monetary teaching embodiments of the present invention may be applied to virtually any monetary system using a base unit of currency that is divided into smaller fractional units. The insert 402 of FIG. 4 is quite similar to the insert 202 of FIG. 2, having opposite first and second major peripheries 404 and 406, each of which is marked with appropriate fractional divisions 416a and 416b for the monetary units used. The span or major width 414 of the insert recess 412 is essentially equal to the major span or width of the underlying board 102 into which the insert 402 is placed for use. However, rather than placing a representation of a U.S. monetary unit on the recess 412, a representation 413 of a one euro coin is shown.

Accordingly, the various monetary fractional pieces provided with the insert 402 are sized and marked to correspond with various euro coins that are fractions of the basic euro denomination, which is the one-euro coin. In this example, five larger fractional monetary pieces 418a through 418e are shown, with each having a width 420 subtending ⅕ of the span or width 414 of the insert 402. The pieces 418a through 418e are each marked with a twenty-cent euro coin representation 421, with each such coin having a value of ⅕ of the one-euro coin shown in the representation 413 in the insert recess 412. A series of ten intermediate size fractional monetary pieces is also provided, with three such pieces 422a through 422c being shown in FIG. 4. Each intermediate piece has a width or span 424 equal to one half of the width 420 of one of the larger ⅕ euro pieces 418a through 418e, with two such intermediate pieces, e.g., pieces 422b and 422c, subtending a total width equal to that of one of the larger ⅕ euro pieces. Accordingly, each of the 1/10 pieces is marked with a ten-cent euro representation 425.

In addition to the above pieces, a series of twenty smaller pieces is provided, with each of the smaller pieces representing 1/20 of a euro. Four such pieces 426a through 426d are illustrated in FIG. 4, with each having a width or span 428 equal to one fourth of the width or span 420 of one of the larger pieces 218a through 218e. Accordingly, each of the smaller pieces, e.g., pieces 426a through 426d, is marked with a five-cent euro representation 429. It will be seen that other groups of pieces having sizes corresponding to other euro coin denominations may be provided as desired. Smallest denominations may be represented in the manner shown for the pieces 326a through 326c of FIG. 3. Also, while color is not indicated for the euro fractional monetary embodiment 400 illustrated in FIG. 4, it will be recognized that opposite surfaces of the various fractional pieces may be colored, shaded, marked, or designated differently from one another if so desired, similarly to the manner shown in FIGS. 1 and 2 and discussed further above.

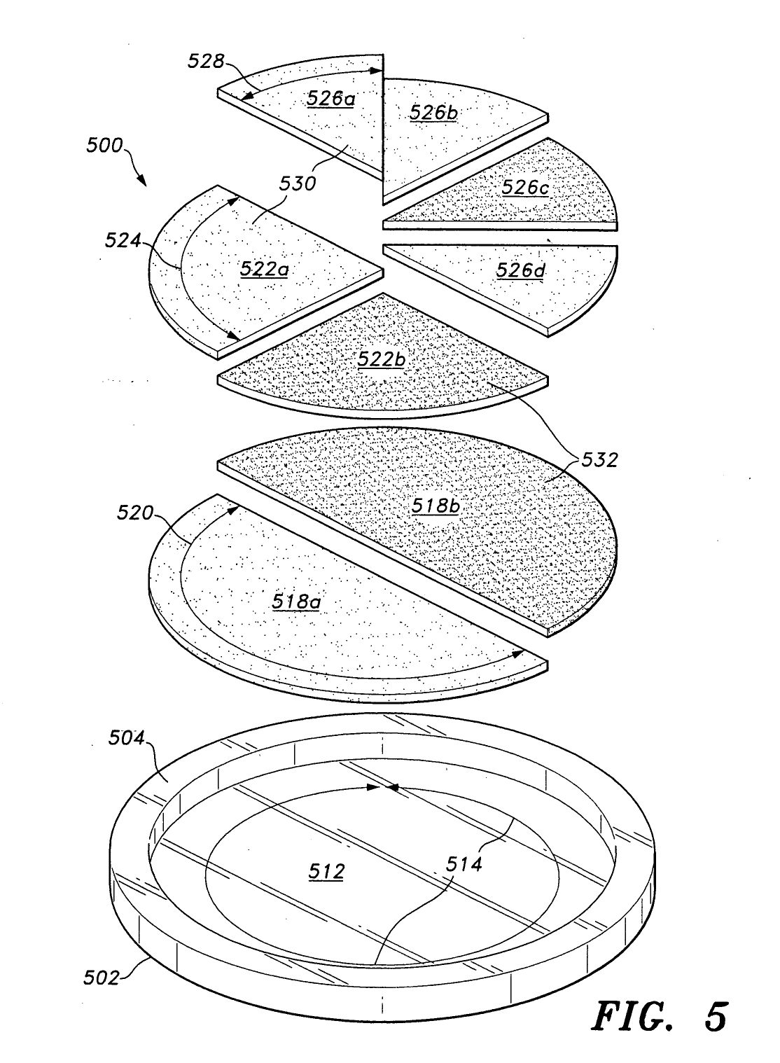

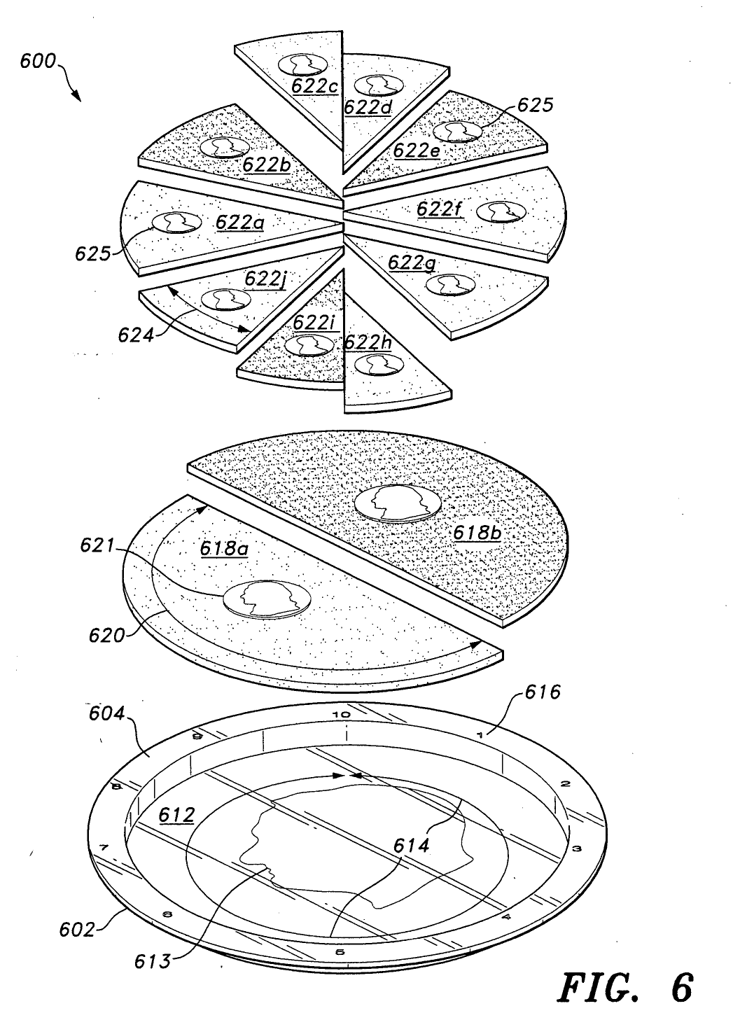

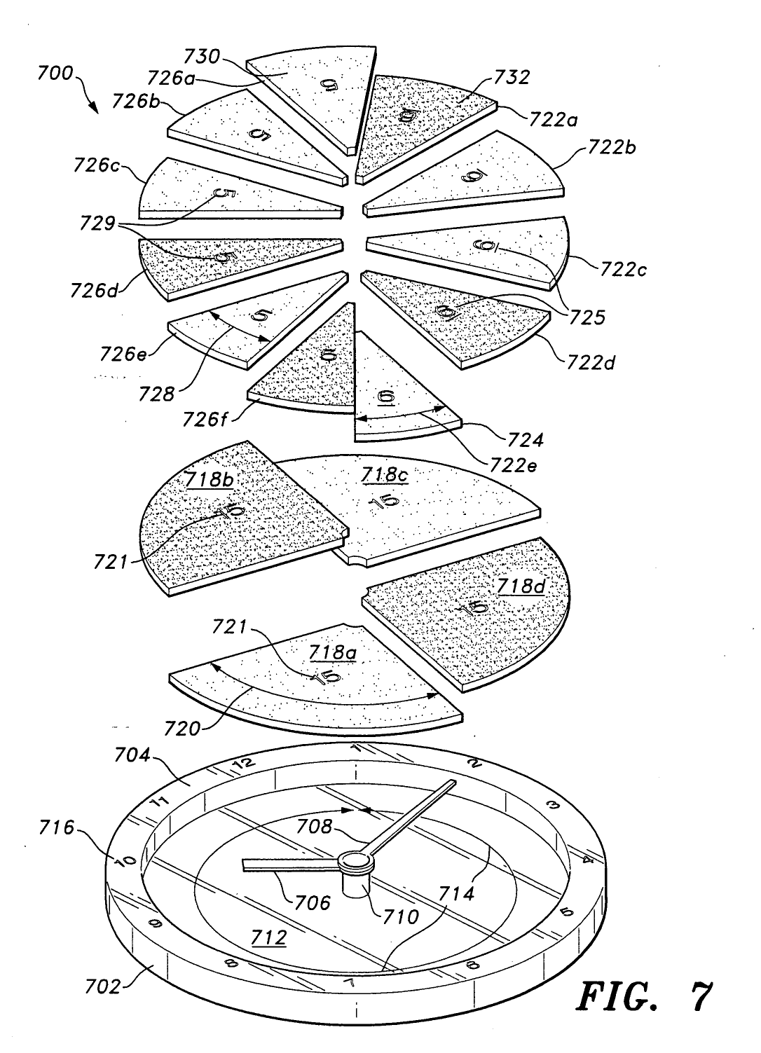

FIG. 5 illustrates a fourth embodiment 500 of the present device for teaching fractional mathematical concepts, wherein the board 502 has a circular configuration and the fractional pieces are each in the form of a circular sector subtending an arc equal to a fraction of the circumferential span of the circular board. The board 502 has much the same structure as the board 102 of FIGS. 1, 3, and 4, in that the board 502 includes a raised peripheral edge 504 forming a continuous periphery defining a central recess 512 therein. The recess 512 subtends a circumferential span 514 representing unity, and extends around the central recess 512 and concentric to the circumferential periphery 504. The circumferential peripheral edge 504 may include a series of numerical designators thereon representing arithmetical, monetary, or other values or quantities as desired, generally as shown on the opposed peripheral edges 104 and 106 of FIG. 1. Examples of such are illustrated in the embodiments of FIGS. 6 and 7, and discussed further below.

A series of relatively thin, flat, planar fractional pieces is provided for removable placement within the central recess 512 of the board 502, with each of the pieces being in the form of a circular sector. Each series of pieces comprises a group of identically sized pieces each having an arcuate width or span less than the circumferential span 514 of the board recess 512, with all of the pieces in any one group having a total width equal to the board recess span 514.

In the example of FIG. 5, three different series of fractional pieces are shown. The first set or group comprising the largest pieces, e.g., pieces 518a and 518b, comprises two pieces, with each piece having an arcuate span or width 520 subtending one half of the circumferential span 514 of the central recess 512. The next group or set of pieces comprises a series of four intermediate pieces, with two such pieces 522a and 522b shown in FIG. 5. Each of the intermediate pieces has a width 524 subtending one quarter of the central recess span 514.

A third set of pieces comprises a series of eight smaller pieces of which four are shown in FIG. 5, i.e., 526a through 526d. Each of these smaller pieces has a width 528 subtending one eighth of the span 514 of the central recess 512. Thus, each piece represents the denominator of a fraction, with the denominator being equal to the number of pieces within each group or set. One or more of the smaller pieces 526a, etc. could be subdivided to form even smaller pieces, if so desired, but this may not be practicable.

Alternatively, one or more of the smaller fractional pieces 526a, etc. could be marked with radial lines indicating the division of the pieces into still smaller components, while still maintaining a practicable size for handling the pieces. It will be seen that the groups of pieces representing half, quarter, and eighth fractions of the unit represented by the circumferential span 514 of the board recess 512 may be adjusted as desired, with the number of pieces and corresponding fractional denominator for each group or set being any practicable integer as desired.

A single group of identical fractional pieces may be used to form a single complete stratum or layer of pieces within the central recess 512, completely filling the central recess, if so desired, with other groups of identical pieces being placed thereon to form multiple layers or strata of fractional pieces. Alternatively, fractional pieces of different groups may be placed within the same stratum to indicate the equivalency or relative value of a series of smaller pieces compared to a single one or smaller number of larger pieces. In the example of FIG. 5, it will be seen that the width 520 of a single larger fractional piece 518a subtends ½, or 50%, of the total circumferential span 514 of the board recess 512, thus requiring two such pieces to fill the recess 512 completely. In turn, two intermediate width pieces 522a and 522b are shown disposed above the larger fractional piece 518a. As each of the pieces 522a and 522b has an arcuate width 524 equal to one fourth of the total arcuate span 514 of the circular board recess 512, two such pieces 522a and 522b are equal in arcuate width to one of the larger ½ pieces 518a. The series of four ⅛ width pieces 526a through 526d will be seen to have a total width equal to 4/8, or ½, of the arcuate span 520 of one of the half width pieces 518a or 518b, with eight such ⅛ pieces being used to cover the entire area of the circular recess 512 of the board 502. The various fractional pieces may be mixed and matched in various layers or strata to show the equivalencies of various fractions, generally as described above.

It will be noted that the various fractional pieces 518a through 526d, etc., are provided in two different colors or shades. For example, a first surface 530 of each of the pieces could be shaded in red, with the opposite second surface 532 colored black. The use of red and black are particularly suitable for embodiments of the present invention representing monetary fractions, i.e., subtraction and addition of monetary values or profit and loss. However, other colors may be used as desired.

FIG. 6 of the drawings illustrates a fifth embodiment 600 of the present fractional teaching devices, comprising a circular insert 602 which may be used with the circular board 502 of FIG. 5 and a series of fractional pieces for teaching monetary values. The insert 602 essentially serves the same function as the circular board 502, i.e., the insert includes a raised peripheral edge 604 forming a continuous periphery defining a central recess 612 therein. The recess 612 subtends a circumferential span 614 representing unity, and extends around the central recess 612 and concentric to the circumferential periphery 604. The circumferential peripheral edge 604 may include a series of numerical designators 616 thereon representing arithmetical, monetary, or other values or quantities as desired, generally as shown on the opposed peripheral edges 104 and 106 of FIG. 1.

The purpose of the insert 602 is to provide different numerical designators along the circumferential upper edge or periphery 604 of the device, which may be used to indicate different fractions or functions for the use of the device. In the example of the insert 602 of FIG. 6, the numerical designators 616 are graduated in tenths. This permits the insert 602 to be used for the teaching of relative monetary values found in coin or other divisions of a basic monetary unit, e.g., nickels, pennies, etc., with a dime being the basic monetary unit. Accordingly, the recess 612 of the insert 602 may include a representation 613 of the basic monetary unit thereon. The inventive concept of FIG. 6 may be expanded to cover other coins or other than U.S. monetary systems as well, as exemplified in FIG. 4 and discussed further above. It will also be noted that the information provided on the insert 602 could be applied to a board similar to the board 502 of FIG. 5, if so desired.

A series of relatively thin, flat, planar fractional monetary pieces is provided for removable placement within the central recess 612 of the insert 602, with each of the pieces being in the form of a circular sector. These monetary pieces are quite similar to the pieces 518a through 526d shown in FIG. 5 of the drawings and discussed further above, differing only in that each of the fractional monetary pieces of FIG. 6 includes a representation of a coin thereon corresponding to the fractional value of the piece. In the example of FIG. 6, two different series of fractional pieces are shown. The first set or group comprising the largest pieces, e.g., pieces 618a and 618b, comprises two pieces, with each piece having a width 620 subtending one half of the circumferential span 614 of the central recess 612 of the insert 602 and representing the value of a nickel, or 5 cents. A 5-cent coin symbol or representation 621 may be provided upon each of the ½ width monetary fractional pieces.

The next group or set of pieces comprises a series of ten intermediate pieces 622a through 622j, each having an arcuate width 624 subtending one tenth of the central recess circumferential span 614 of the insert 602. As there are ten such pieces, a penny representation 625 or coin having a value of one tenth of the monetary unit represented by the circumferential span 614 of the circular insert 602 may be provided on each piece. It will be seen that if a larger value coin is represented in the recess 612 of the insert 602, then more groups of fractional monetary pieces having different arcuate widths or spans and corresponding values from one another may be provided.

FIG. 7 of the drawings illustrates a sixth embodiment 700 of the present invention, in which a circular board 702 (or alternatively, insert for a circular board) is used to teach time increments. The circular board 702 has a general configuration much like the circular board 502 of FIG. 5, i.e., having a continuous circular raised periphery 704 defining a circular central recess 712 therein, with the central recess subtending a circumferential span 714. However, the board 702 of FIG. 7 further includes an hour hand 706 and minute hand 708, extending from a central pivot point 710 and independently positionable thereon. A conventional clock motor drive (not shown) could be used to drive the two hands 706 and 708, if so desired, but the intent of the time teaching embodiment 700 of FIG. 7 is to allow the user or teacher to position the two hands as desired, to demonstrate various time increments and their indication by means of the hands. The raised circumferential periphery 704 preferably includes a series of numerical designators 716 in accordance with conventional clock or timepiece markings. Alternatively, a circular insert similar to the insert 602 of FIG. 6 (but including clearance for the clock hands 706 and 708) could be provided with some alternative numerical designators, e.g., twenty-four hour clock markings, etc.

A series of relatively thin, flat, planar fractional pieces is provided for removable placement within the central recess 712 of the board 702, with each of the pieces being in the form of a circular sector. Each series of pieces comprises a group of identically sized pieces each having an arcuate width or span less than the circumferential span 714 of the board recess 712, with all of the pieces in any one group having a total width equal to the board recess span 714. Each piece further includes a truncated relief at the apex thereof, for clearance for the central clock hand pivot 710.

In the example of FIG. 7, three different series of fractional pieces are shown. The first set or group comprising the largest pieces, i.e., pieces 718a through 718d, comprises four pieces, with each piece having an arcuate span or width 720 subtending one quarter of the circumferential span 714 of the central recess 712. The four quarter-hour pieces 718a through 718d may be marked with appropriate indicators 721 to indicate their value or represented time span, e.g., 15, to indicate the 15-minute time increment represented by each quarter hour piece. The next group or set of pieces comprises a series of five intermediate pieces 722a through 722e. Each of the intermediate pieces has an arcuate width or span 724 subtending one tenth of the central recess span 714, or a time span of one tenth of an hour or six minutes.

Accordingly, each of these pieces 722a through 722e may be marked to show the time increment 725 represented, i.e., six minutes. It will be seen that a total of ten such pieces may be provided to cover the entire central recess 712 of the clock board 702, if so desired. A third set of pieces comprises a series of six smaller pieces 726a through 726f. Each of these smaller pieces has a width 728 subtending one sixth of the span 714 of the central recess 712. Thus, each piece represents a time span of five minutes, with six such pieces equaling thirty minutes or half an hour, and twelve such pieces (if provided) equaling one hour and completely covering the clock board recess 712 when placed thereon. The corresponding time period may be indicated by an appropriate numerical designator 729 placed upon each of the pieces 726a through 726f.

As in the other embodiments of the present invention discussed further above, the various fractional time pieces could be further subdivided into smaller increments, or alternatively marked with one or more radial lines to indicate smaller time increments. Other fractional time increments may be provided as desired, e.g., one third hour pieces representing twenty minutes, one twentieth hour pieces representing three minutes each, etc. as desired. As in the case of the other embodiments of the present invention, a single group of identical fractional pieces may be used to form a single complete stratum or layer of pieces within the central recess 712, completely filling the central recess, if so desired, with other groups of identical pieces being placed thereon to form multiple layers or strata of fractional pieces. Alternatively, fractional pieces of different groups may be placed within the same stratum to indicate the equivalency or relative value of a series of smaller pieces compared to a single one or smaller number of larger pieces.

It will be noted that the various fractional pieces 718a through 726f are provided in two different colors or shades. For example, a first surface 730 of each of the pieces could be shaded in red, with the opposite second surface 732 colored black. Other colors may be used as desired. The provision of different colors on opposite surfaces of the various fractional time pieces serves to facilitate an understanding of such concepts as “half past the hour,” “quarter to the hour,” etc.

In conclusion, the devices for teaching elementary fractional concepts provide a series of tools that greatly facilitate the ability of the student to visualize the concepts being taught. The various embodiments include devices for teaching abstract fractional concepts, as well as monetary and time concepts. Some concepts, e.g., the basic abstract fractional concept, are adapted for a linear, rectangular presentation, others, e.g., the teaching of time using a conventional clock configuration, are better suited to a circular presentation or configuration. However, it will be seen that either configuration as disclosed herein may be adapted to the teaching of virtually any fractional concepts. Accordingly, the devices for teaching elementary fractional concepts will prove to be most useful in the classroom and as educational toys for teaching such concepts.

It is to be understood that the present invention is not limited to the embodiments described above, but encompasses any and all embodiments within the scope of the following claims.

I claim:

1. A device for teaching elementary fractional concepts, comprising:
a board having a raised periphery defining a central recess therein, the recess subtending a span;
a plurality of numerical designators disposed upon the raised periphery; and
a first group and a second group of fractional pieces selectively and removably installed within the central recess of the board and forming a first stratum and a second stratum of fractional pieces when placed within the recess of the board, the fractional pieces within each of the groups being a plurality of pieces equal in size to one another, each of the groups having pieces distinctive in size and number, each of the pieces representing a denominator of a fraction, the pieces within each of the groups having a total span equal to the span of the central recess of the board.

2. The device for teaching elementary fractional concepts according to claim 1, wherein:
the central recess of the board has a rectangular configuration, the span of the central recess being equal to the length of the central recess; and
each of the fractional pieces has a rectangular shape having a width corresponding to a fraction of the span of the central recess.

3. The device for teaching elementary fractional concepts according to claim 1, wherein:
the central recess of the board has a circular configuration, the span of the central recess subtending the circumference of the central recess; and
each of the fractional pieces comprises a circular sector subtending an arc corresponding to a fraction of the span of the central recess.

4. The device for teaching elementary fractional concepts according to claim 3, further including:
at least an hour hand and a minute hand pivotally secured concentrically within the central recess; and
a time quantity representation disposed upon each of the fractional pieces, the amount of each time quantity representation corresponding to the size of the fractional piece upon which the time quantity representation is disposed.

5. The device for teaching elementary fractional concepts according to claim 1, further including:
an insert removably installed within the central recess of the board, the insert having a raised periphery defining a central recess therein; and
a plurality of numerical designators disposed upon the raised periphery of the insert.

6. The device for teaching elementary fractional concepts according to claim 1, wherein:
the plurality of numerical designators of the raised periphery comprise monetary divisions;
a monetary coin representation is disposed upon each of the fractional pieces; and
each coin representation has a value corresponding to the size of the fractional piece upon which the coin representation is disposed.

7. The device for teaching elementary fractional concepts according to claim 6, wherein at least some of the fractional pieces further include representations of a plurality of smallest denomination coins disposed thereon, corresponding to the fractional value represented by the size of the fractional piece upon which the smallest denomination coin representations are disposed.

8. The device for teaching elementary fractional concepts according to claim 1, wherein each of the fractional pieces has a first side having a first color disposed thereon, and a second side opposite the first side having a second color disposed thereon.

9. A device for teaching elementary fractional concepts, comprising:
a board having a raised periphery defining a rectangular central recess therein, the recess having a length defining the span of the rectangular recess, the raised periphery having a plurality of fractional numerical designators thereon;
a first group and a second group of fractional pieces selectively and removably installed within the central recess of the board and forming a first stratum and a second stratum of fractional pieces, each of the fractional pieces having a rectangular shape and a width corresponding to a fraction of the span of the central recess, the fractional pieces within each of the groups being a plurality of pieces equal in size to one another, each of the groups having pieces distinctive in size and number, each of the pieces representing a denominator of a fraction, the pieces within each of the groups having a total span equal to the span of the central recess of the board.

10. The device for teaching elementary fractional concepts according to claim 9, further including:
an insert removably installed within the central recess of the board, the insert having a raised periphery defining a central recess therein; and
a plurality of numerical designators disposed upon the raised periphery of the insert.

11. The device for teaching elementary fractional concepts according to claim 9, wherein:
the plurality of numerical designators of the raised periphery comprise monetary divisions;
a monetary coin representation is disposed upon each of the fractional pieces; and
the value of each coin representation corresponds to the size of the fractional piece upon which the coin representation is disposed.

12. The device for teaching elementary fractional concepts according to claim 11, wherein at least some of the fractional pieces further include representations of a plurality of smallest denomination coins disposed thereon, corresponding to the fractional value represented by the size of the fractional piece upon which the smallest denomination coin representations are disposed.

13. The device for teaching elementary fractional concepts according to claim 9, wherein each of the fractional pieces has a first side having a first color disposed thereon, and a second side opposite the first side having a second color disposed thereon.

14. A device for teaching elementary fractional concepts, comprising:
a board having a raised periphery defining a central recess therein, the recess having a circular configuration defining a span subtending the circumference of the central recess, the raised periphery having a plurality of numerical designators thereon;
a first group and a second group of fractional pieces selectively and removably installed within the central recess of the board and forming a first stratum and a second stratum of fractional pieces, each of the fractional pieces being a circular sector subtending an arc corresponding to a fraction of the span of the central recess, the fractional pieces within each of the groups being a plurality of pieces equal in size to one another, each of the groups having pieces distinctive in size and number, each of the pieces representing a denominator of a fraction, the pieces within each of the groups having a total span equal to the span of the central recess of the board.

15. The device for teaching elementary fractional concepts according to claim 14, further including:
at least an hour hand and a minute hand pivotally secured concentrically within the central recess;
a time quantity representation disposed upon each of the fractional pieces, the amount of each time quantity representation corresponding to the size of the fractional piece upon which the time quantity representation is disposed.

16. The device for teaching elementary fractional concepts according to claim 14, further including:
an insert removably installed within the central recess of the board, the insert having a raised periphery defining a central recess therein; and
a plurality of numerical designators disposed upon the raised periphery of the insert.

17. The device for teaching elementary fractional concepts according to claim 14, wherein:
the plurality of numerical designators of the raised periphery comprise monetary divisions;
a monetary coin representation is disposed upon each of the fractional pieces; and
the value of each coin representation corresponds to the size of the fractional piece upon which the coin representation is disposed.

18. The device for teaching elementary fractional concepts according to claim 17, wherein at least some of the fractional pieces further include representations of a plurality of smallest denomination coins disposed thereon, corresponding to the fractional value represented by the size of the fractional piece upon which the smallest denomination coin representations are disposed.

19. The device for teaching elementary fractional concepts according to claim 14, wherein each of the fractional pieces has a first side having a first color disposed thereon, and a second side opposite the first side having a second color disposed thereon.
